(19) United States
(12) Patent Application Publication
(10) Pub. No.: US 2024/0362297 A1
(43) Pub. Date: Oct. 31, 2024

(54) OUTER PRODUCT-BASED MATRIX-VECTOR MULTIPLICATION OPERATION APPARATUS FOR ACCELERATING VECTOR OPERATION AND METHOD USING THE SAME

(71) Applicant: ELECTRONICS AND TELECOMMUNICATIONS RESEARCH INSTITUTE, Daejeon (KR)

(72) Inventor: Hye-Ji KIM, Daejeon (KR)

(21) Appl. No.: 18/502,330

(22) Filed: Nov. 6, 2023

(30) Foreign Application Priority Data
Apr. 26, 2023 (KR) 10-2023-0054612

(51) Int. Cl. G06F 17/16; G06F 7/544

(52) U.S. Cl. CPC G06F 17/16; G06F 7/5443

(57) ABSTRACT

Disclosed herein are an outer product-based matrix-vector multiplication operation apparatus and a method using the same. The outer product-based matrix-vector multiplication operation apparatus includes internal calculators, each configured to generate an accumulated value by performing a Multiply-Accumulation (MAC) operation, an internal data transmission path configured to simultaneously provide a vector element to two or more internal calculators, and at least one multiplexer configured to select any one of the vector element and a vector of a matrix, wherein a first input port of each of the internal calculators is connected to one of vectors of the matrix and a second input port of each of the internal calculators is connected to the vector element.

### CROSS REFERENCE TO RELATED APPLICATION

This application claims the benefit of Korean Patent Application No. 10-2023-0054612, filed Apr. 26, 2023, which is hereby incorporated by reference in its entirety into this application.

### BACKGROUND OF THE INVENTION

### 1. Technical Field

The present disclosure relates generally to outer product-based matrix-vector multiplication operation technology for accelerating vector operations, and more particularly to a hardware architecture and an operation method using the hardware architecture, which process matrix-vector operations of a neural network acceleration semiconductor circuit at high speed in combination with a data lightweighting technique based on an outer product calculator.

### 2. Description of Related Art

Existing hardware architectures for accelerating artificial neural networks are focusing on fast processing of matrix-matrix multiplication operations. However, as the architectures of artificial neural networks have recently diversified, there is a growing trend in the usage of not only matrix-matrix multiplication operations but also matrix-vector multiplication operations. Particularly, in the case of a transformer neural network architecture, which revolves around an attention layer, each primary operation is composed of matrix-vector multiplications, thus further emphasizing the necessity for matrix-vector multiplications.

However, because the structure of an artificial intelligence accelerator that is currently developed is optimized for matrix-matrix multiplication operations having the highest computational complexity, a problem may arise in that speed enhancement for matrix-vector multiplication operations is greatly deteriorated compared to matrix-matrix multiplication operations and accelerator utilization is reduced.

This phenomenon is theoretically caused by the limitations of memory bandwidth. That is, in order to enhance the speed of matrix-vector multiplication operations and increase accelerator utilization, the amount of data that can be received per second from memory needs to be increased. However, this is a problem directly linked to hardware area and the complexity of the entire calculator, and in existing matrix-matrix multiplication operations, memory bandwidth is already fully utilized for performing operations. In other words, if only memory bandwidth is simply increased to accelerate matrix-vector multiplication operations, a problem may arise in that a situation where the memory bandwidth is not fully utilized in matrix-matrix multiplication operations occurs, thus merely increasing complexity in the entire system and causing unnecessary system operations.

Therefore, to minimize additional hardware usage, there are required a dedicated operation (calculation) structure and methodology that are capable of enhancing the speed of matrix-vector multiplication operations by employing the conventional accelerator structure optimized for matrix-matrix multiplications without change and by fully utilizing memory bandwidth to increase the utilization rate of calculators.

### PRIOR ART DOCUMENTS

### Patent Documents

(Patent Document 1) Korean Patent Application Publication No. 10-2020-0070088, Date of Publication: Jun. 17, 2020 (Title: General Matrix-Matrix Multiplication Dataflow Accelerator Semiconductor Circuit)

### SUMMARY OF THE INVENTION

Accordingly, the present disclosure has been made keeping in mind the above problems occurring in the prior art, and an object of the present disclosure is to provide a hardware architecture, which can accelerate matrix-vector multiplication operations while reusing the matrix-matrix multiplication operation apparatus structure of Artificial Intelligence (AI) semiconductor.

Another object of the present disclosure is to maximize a memory interface utilization rate and improve the utilization of calculators by transmitting a larger Number of operands at the same memory bandwidth in combination with a data lightweighting technique.

A further object of the present disclosure is to expand the utilization range of AI semiconductor and improve learning ability by enhancing the speed of the primary operation (i.e., matrix-vector multiplication) of the next-generation neural network architecture.

In accordance with an aspect of the present disclosure to accomplish the above objects, there is provided an outer product-based matrix-vector multiplication operation apparatus, including internal calculators, each configured to generate an accumulated value by performing a Multiply-Accumulation (MAC) operation; an internal data transmission path configured to simultaneously provide a vector element to two or more internal calculators; and at least one multiplexer configured to select any one of the vector element and a vector of a matrix, wherein a first input port of each of the internal calculators is connected to one of vectors of the matrix and a second input port of each of the internal calculators is connected to the vector element.

One element port, among data input ports of an array composed of the internal calculators, may be allocated to the vector element, and vector ports, other than the one element port, among the data input ports, may be allocated to the vectors of the matrix.

When each of the vectors of the matrix is multi-data into which two pieces of half-precision data, having decreased precision by reducing a number of bits in a mantissa and an exponent in a floating-point data type, are combined with each other, the multi-data may be simultaneously input to two internal calculators.

One of the two internal calculators may perform an operation based on an upper bit by masking a lower bit in the multi-data, and a remaining one of the two internal calculators may perform an operation based on a lower bit by masking an upper bit in the multi-data.

The two internal calculators may be located in an identical row or an identical column in the array, and may be arranged in an order of a first internal calculator which performs an operation based on the upper bit and a second internal calculator which performs an operation based on the lower bit.

The at least one multiplexer may be provided such that the vector element is capable of being provided to all internal calculators to which the vector of the matrix is allocated in consideration of a location of the element port.

The multi-data may be generated by performing type conversion in which a data type of half-precision data or data having a size smaller than that of the half-precision data is taken into consideration.

When the data type of the half-precision data is an exponent-bias floating-point data type, a range of a result value of a matrix-vector multiplication operation may be corrected by subtracting a preset exponent bias from the result value.

In accordance with another aspect of the present disclosure to accomplish the above objects, there is provided an outer product-based matrix-vector multiplication operation method, including simultaneously providing, through an internal data transmission path, a vector element to two or more internal calculators; selecting, by at least one multiplexer, any one of a vector element and a vector of a matrix; and generating, by each of internal calculators, an accumulated value by performing a Multiply-Accumulation (MAC) operation, wherein a first input port of each of the internal calculators is connected to one of vectors of the matrix and a second input port of each of the internal calculators is connected to the vector element.

One element port, among data input ports of an array composed of the internal calculators, may be allocated to the vector element, and vector ports, other than the one element port, among the data input ports, may be allocated to the vectors of the matrix.

When each of the vectors of the matrix is multi-data into which two pieces of half-precision data, having decreased precision by reducing a number of bits in a mantissa and an exponent in a floating-point data type, are combined with each other, the multi-data may be simultaneously input to two internal calculators.

Wherein one of the two internal calculators may perform an operation based on an upper bit by masking a lower bit in the multi-data, and a remaining one of the two internal calculators may perform an operation based on a lower bit by masking an upper bit in the multi-data.

The two internal calculators may be located in an identical row or an identical column in the array, and may be arranged in an order of a first internal calculator which performs an operation based on the upper bit and a second internal calculator which performs an operation based on the lower bit.

The at least one multiplexer may be provided such that the vector element is capable of being provided to all internal calculators to which the vector of the matrix is allocated in consideration of a location of the element port.

The multi-data may be generated by performing type conversion in which a data type of half-precision data or data having a size smaller than that of the half-precision data is taken into consideration.

When the data type of the half-precision data is an exponent-bias floating-point data type, a range of a result value of a matrix-vector multiplication operation may be corrected by subtracting a preset exponent bias from the result value.

### BRIEF DESCRIPTION OF THE DRAWINGS

The above and other objects, features and advantages of the present disclosure will be more clearly understood from the following detailed description taken in conjunction with the accompanying drawings, in which:

FIGS. 1 and 2 are diagrams illustrating an example of the structure of an outer product-based matrix multiplication operation apparatus;

FIGS. 3 to 5 are diagrams illustrating the structure of an outer product-based matrix-vector multiplication operation apparatus according to an embodiment of the present disclosure;

FIG. 6 is a diagram illustrating an example of a multiplexer applied to a matrix-vector multiplication operation apparatus according to the present disclosure;

FIG. 7 is a diagram illustrating an example of a data structure allocated to a data input port of an array during the matrix-vector multiplication operation illustrated in FIG. 2;

FIG. 8 is a diagram illustrating an example of a data structure allocated to a data input port of an array during the matrix-vector multiplication operation illustrated in FIG. 3;

FIG. 9 is a diagram illustrating an example of a data structure allocated to a data input port of an array during the matrix-vector multiplication operation illustrated in FIGS. 4 and 5;

FIG. 10 is a diagram illustrating an example in which the location of an element port to which B0 is input is changed in the matrix-vector multiplication operation apparatus illustrated in FIG. 3;

FIG. 11 is a diagram illustrating an example in which the location of an element port to which B0 is input is changed in the matrix-vector multiplication operation apparatus illustrated in FIG. 4;

FIGS. 12 and 13 are operation flowcharts illustrating an embodiment of a processing procedure when half-precision data is a block floating-point type or an exponent-bias floating-point type according to the present disclosure; and

FIG. 14 is an operation flowchart illustrating an outer product-based matrix-vector multiplication operation method according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, preferred embodiments of the present disclosure will be described in detail with reference to the attached drawings.

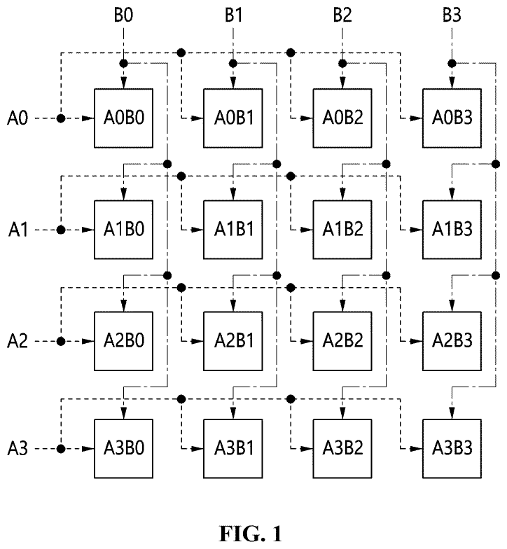

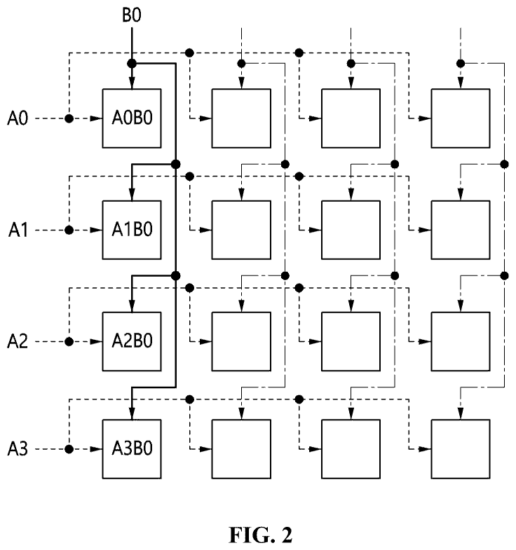

FIGS. 1 and 2 are diagrams illustrating an example of the structure of an outer product-based matrix multiplication operation apparatus (also referred to as an “outer product-based matrix multiplication calculator”).

First, referring to FIG. 1, in the case of a matrix-matrix multiplication operation (or matrix-matrix multiplication), L-dimensional vectors (e.g., A0 to A3 and B0 to B3 of FIG. 1) derived from two input matrixes, respectively, may be received as the input of the operation apparatus, and the result of the operation on the vectors may be generated in the form of an L×L matrix composed of all combinations of individual pieces of data.

Further, FIG. 2 corresponds to a matrix-vector multiplication operation (or matrix-vector multiplication). As shown in FIG. 2, when an existing matrix-matrix multiplication operation structure is taken without change, operations may be performed by receiving a vector element (B0 of FIG. 2) and L-dimensional vectors (A0 to A3 of FIG. 2) of a matrix in each operation cycle, and L-dimensional vector data may be generated as the output thereof.

However, the operation structure such as that illustrated in FIG. 2, memory bandwidth usage is remarkably deteriorated due to the input of the element B0, and calculator utilization is also decreased.

Therefore, the present disclosure proposes the structure of an outer product-based matrix-vector multiplication operation apparatus and a method thereof, which enhance a computational speed about four times that of a conventional matrix-vector multiplication operation by improving calculator utilization to about four times that of the conventional matrix-vector multiplication operation when compared with the conventional matrix-vector multiplication operation while fully utilizing a given memory bandwidth.

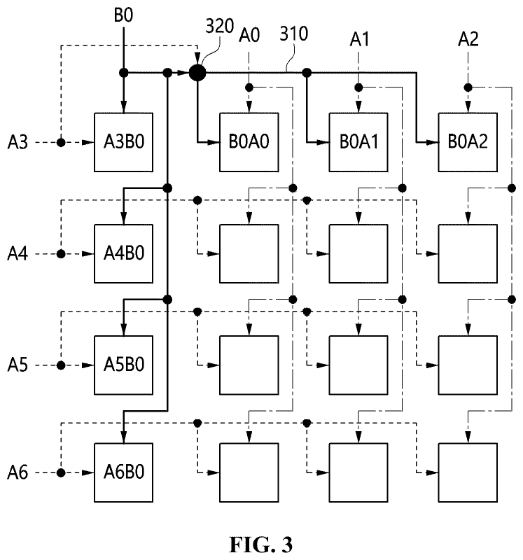

FIGS. 3 to 5 are diagrams illustrating the structure of an outer product-based matrix-vector multiplication operation apparatus according to an embodiment of the present disclosure.

Referring to FIGS. 3 to 5, the outer product-based matrix-vector multiplication operation apparatus according to the embodiment of the present disclosure may be operated in such a way as to expansively allocate the vectors of a matrix (A0 to A6 of FIGS. 3 to 5) to a memory interface which conventionally receives a vector element (B0 of FIGS. 3 to 5).

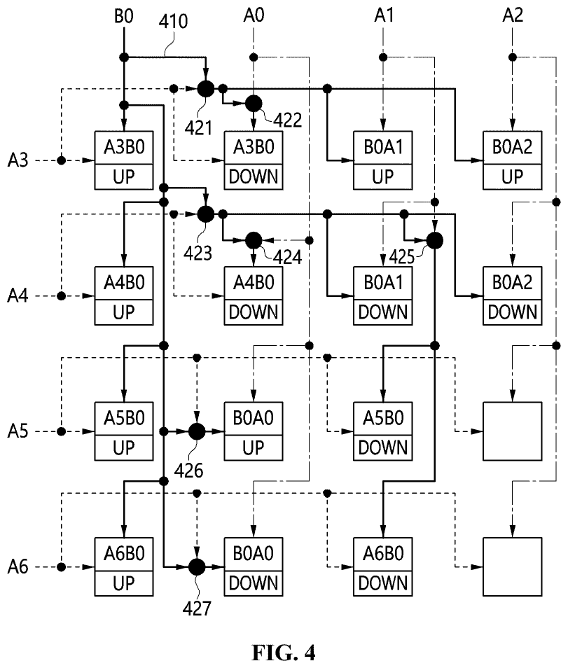

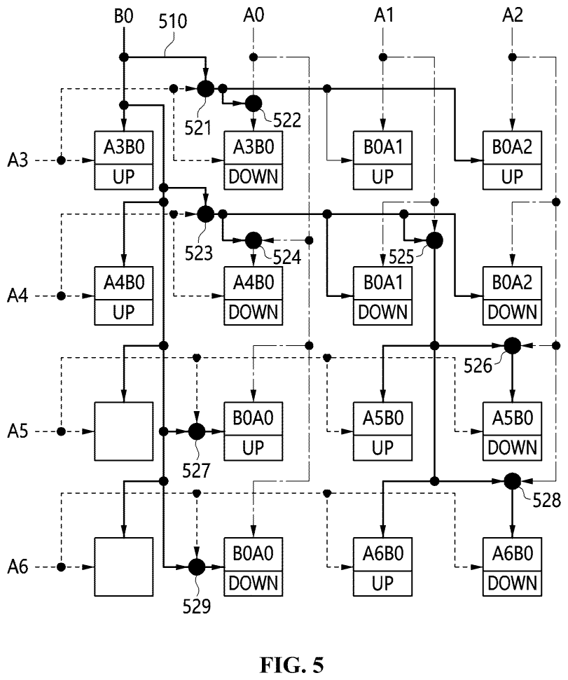

In this case, the embodiment of FIG. 3 shows the structure of an outer product-based matrix-vector multiplication operation apparatus, which receives an element B0 derived from a vector to utilize 2L-1 internal calculators, and the embodiments of FIGS. 4 and 5 show the structure of an outer product-based matrix-vector multiplication operation apparatus, which receives the element B0 derived from a vector to utilize 4L-2 internal calculators.

Referring to FIGS. 3 to 5, the outer product-based matrix-vector multiplication operation apparatus according to the embodiment of the present disclosure may include internal calculators, each of which performs a Multiply-Accumulation (MAC) operation and then generates an accumulated value, an internal data transmission path 310, 410, or 510 which simultaneously provides the vector element to two or more internal calculators, and at least one multiplexer 320, 421 to 427, or 521 to 529, each of which selects any one of the vector element and the vector of a matrix.

In this case, a first input port of each of the internal calculators may be connected to one of vectors of the matrix and a second input port of each of the internal calculators may be connected to the vector element.

In this case, one element port, among data input ports of an array composed of the internal calculators, may be allocated to the vector element, and vector ports of the data input ports, other than the one element port, may be allocated to the vectors of the matrix.

In this case, at least one multiplexer may be provided such that the vector element can be provided to all internal calculators to which the vectors of the matrix are allocated in consideration of the location of the element port.

For example, FIG. 3 corresponds to an embodiment of the matrix-vector multiplication operation apparatus, which may enhance the computational speed about twice that of the conventional structure illustrated in FIG. 2 by adding only one 2:1 multiplexer.

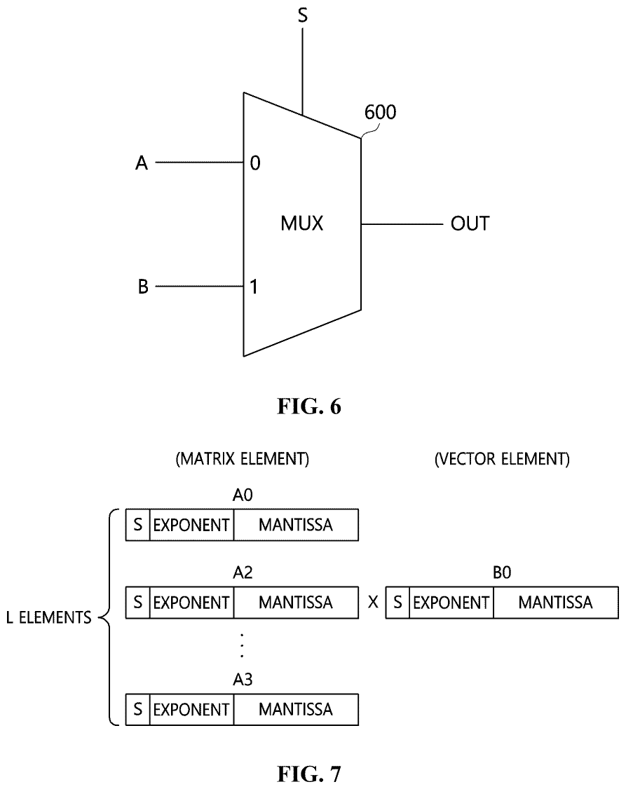

In this case, the 2:1 multiplexer according to the present disclosure may correspond to the form illustrated in FIG. 6. For example, referring to a multiplexer 600 illustrated in FIG. 6, the multiplexer 600 may be operated by receiving, as input values, a vector element B input through one element port and vector A of a matrix input through multiple vector ports. In this case, the multiplexer 600 may be operated such that, when the value of S is 0, the vector A of the matrix is determined to be output OUT and the output OUT is transferred, or such that, when the value of S is 1, the vector element B is determined to be output OUT and the output OUT is transferred.

Here, the value of S of the multiplexer 600 may be determined depending on which value has been input to an internal calculator to which the output OUT of the multiplexer 600 is transferred. For example, because each of the internal calculators according to the present disclosure needs to be operated by receiving only one vector of a matrix and one vector element, the vector A of the matrix may be controlled to be transferred to an internal calculator by setting the S value of the multiplexer 600 to 0 if the vector element B has already been input to the internal calculator to which the output OUT of the multiplexer 600 is transferred. In contrast, if the vector A of the matrix has already been input to the internal calculator to which the output OUT of the multiplexer 600 is transferred, the vector element B may be controlled to be transferred to the internal calculator by setting the S value of the multiplexer 600 to 1.

The structure illustrated in FIG. 3 illustrates an embodiment in which element B0 derived from the vector is received to utilize 2L-1 internal calculators, wherein interfaces corresponding to a row and a column may fundamentally permit the input of an L-dimensional vector.

In this case, one of the interfaces corresponding to each row and each column illustrated in FIG. 3, that is, data input ports of the array may be fixed at an element port to which the vector element are input. Therefore, the remaining 2L-1 data input ports, other than the one element port, may correspond to vector ports allocated to vectors A0 to A6 derived from the matrix.

Consequently, according to the structure illustrated in FIG. 3, an operation may be performed by receiving 2L-1 vectors A0 to A6 in each cycle, and this operation may shorten operation time by enhancing the computational speed about twice that of the conventional operation scheme illustrated in FIG. 2.

In this case, the element port B0 to which the vector element is input may be located at any of interfaces corresponding to a row or a column, and an operation may be performed when the vector element input to the element port is transferred to all internal calculators A3B0, A4B0, A5B0, A6B0, B0A0, B0A1, and B0A2 to which the vectors of the matrix are allocated through the remaining vector ports A0 to A6.

That is, because the vector element input through the element port needs to be uniformly transferred to the internal calculators allocated to respective vector ports, the internal data transmission path 310 and the multiplexer 320 (2:1 multiplexer (MUX) logic) are additionally required in a conventional matrix multiplication structure.

In the embodiment illustrated in FIG. 3, in order to allocate the element port B0 to all of the internal calculators B0A0, B0A1, and B0A2 allocated to respective vector ports A0, A1, and A2, the structure of FIG. 3 is configured such that B0 input is broadcasted through a 2:1 MUX of A3 and B0.

In this case, when each of the vectors of the matrix is multi-data into which two pieces of half-precision data, having decreased precision by reducing the number of bits in the mantissa and the exponent in a floating-point data type, are combined with each other, the multi-data may be simultaneously input to two internal calculators.

In this case, one of the two internal calculators may perform an operation based on an upper bit by masking a lower bit in the multi-data, and the other of the two internal calculators may perform an operation based on a lower bit by masking an upper bit in the multi-data.

In this case, the two internal calculators are located in the same row or the same column in the array, but they may be arranged in the order of a first internal calculator which performs an operation based on the upper bit, and a second internal calculator which performs an operation based on the lower bit.

For example, FIGS. 4 and 5 corresponds to an embodiment of the structure of a matrix-vector multiplication operation apparatus, which can enhance the computational speed about four times that of the conventional structure illustrated in FIG. 2 by adding a minimum of seven 2:1 multiplexers.

The structures illustrated in FIGS. 4 and 5 represent embodiments in which an element B0 derived from a vector is received and 4L-2 internal calculators are utilized. Here, in the structures illustrated in FIGS. 4 and 5, two pieces of vector data derived from a matrix are input in an integrated form to one data input port of the array, and thus two internal calculators may be simultaneously allocated to one vector port.

Consequently, according to the structure illustrated in FIGS. 4 and 5, an operation may be performed by receiving 4L-2 vectors (up-parts of A0 to A6 and down-parts of A0 to A6) in each cycle, and this operation may shorten the operation time by enhancing the computational speed about four times that of the conventional operation scheme illustrated in FIG. 2.

Here, similar to FIG. 3, in FIGS. 4 and 5, the vector element input through the element port needs to be uniformly transferred to the internal calculators allocated to respective vector ports, and thus the internal data transmission path 410 or 510 and a minimum of seven multiplexers 421 to 427 or 521 to 529 (2:1 MUX Logic) are required in the conventional matrix multiplication structure.

In this case, each of the vectors A0 to A6 of the matrix, input to the internal calculators in FIGS. 4 and 5, may be multi-data including an upper bit UP and a lower bit DOWN corresponding to two pieces of data therein. Therefore, each internal calculator may perform an operation using only required data after masking an upper bit or a lower bit.

In order to allocate the element port B0 to all internal calculators, the embodiment illustrated in FIG. 4 is configured such that B0 input is broadcasted through a 2:1 MUX 421 of A3 and B0, a 2:1 MUX 422 of A0 and B0, a 2:1 MUX 423 of A4 and B0, a 2:1 MUX 424 of A0 and B0, a 2:1 MUX 425 of A1 and B0, a 2:1 MUX 426 of A5 and B0, and a 2:1 MUX 427 of A6 and B0.

In order to allocate the element port B0 to all internal calculators, the embodiment illustrated in FIG. 5 is configured such that B0 input is broadcasted through a 2:1 MUX 521 of A3 and B0, a 2:1 MUX 522 of A0 and B0, a 2:1 MUX 523 of A4 and B0, a 2:1 MUX 524 of A0 and B0, a 2:1 MUX 525 of A1 and B0, a 2:1 MUX 526 of A2 and B0, a 2:1 MUX 527 of A5 and B0, a 2:1 MUX of 528 of A2 and B0, and a 2:1 MUX 529 of A6 and B0.

Furthermore, referring to FIGS. 4 and 5, it can be seen that two internal calculators to which one piece of multi-data is equally input are located in the same row or the same column.

In an example, in FIG. 4, it can be seen that A3B0-UP and A3B0-DOWN corresponding to two internal calculators which receive A3 input are located in the same row. In another example, it can be seen that B0A0-UP and B0A0-DOWN corresponding to two internal calculators which receive A0 input are located in the same column.

In this case, two internal calculators to which one piece of multi-data is equally input may be located in the order of a first internal calculator which performs an operation based on an upper bit in each row and each column, and a second internal calculator which performs an operation based on a lower bit.

In an example, in FIG. 4, two internal calculators which receive A4 input may be located in the order of A4B0-UP and A4B0-DOWN in the same row. In another example, two internal calculators which receive A1 input may be located in the order of B0A1-UP and B0A1-DOWN in the same column.

In this case, the vector ports A0 to A6 illustrated in FIGS. 3 to 5 may transmit data only to designated internal calculators among multiple internal calculators located in a row direction or a column direction. Therefore, input may be bypassed such that data is not transmitted to the remaining internal calculators that are not designated.

Here, the number of internal calculators designated for each of the vector ports A0 to A6 may be determined depending on whether data input to the corresponding port is one piece of data or multi-data into which multiple pieces of data are integrated with each other. In an example, when data input to each vector port is one piece of data, the data may be transmitted by designating only one internal calculator in a row direction or a column direction for each of the vector ports A0 to A6, as illustrated in FIG. 3. In another example, when data input to each vector port is multi-data into which two pieces of data are integrated with each other, the data may be transmitted by designating two internal calculators in a row direction or a column direction for each of the vector ports A0 to A6, as illustrated in FIGS. 4 and 5.

That is, depending on the number of pieces of data that are integrated to generate the multi-data, the number of internal calculators to be designated may be determined, and the number of pieces of data that can be integrated into the multi-data may be related to the size of the array composed of internal calculators.

For example, when the size of the array is 4×4, as illustrated in FIGS. 3 to 5, four internal calculators may be arranged in each row or column, and thus a maximum of two pieces of data may be integrated. In order to perform an operation on multi-data into which three pieces of data are integrated with each other, an operation apparatus having an array size of 6×6 in which six internal calculators can be arranged in each row or each column may be required.

In this case, FIGS. 7 to 9 illustrate examples of the structure of data allocated through each data input port in the conventional matrix-vector multiplication operation structure and the matrix-vector multiplication operation structure according to the present disclosure.

First, the conventional matrix-vector multiplication illustrated in FIG. 7 relates to the conventional matrix-vector multiplication operation structure illustrated in FIG. 2, and may correspond to a structure for multiplying L N-bit vectors (matrix elements) derived from a matrix in each cycle by one N-bit vector element. Here, this structure may be a scheme for processing L operation results in parallel through L internal calculators, respectively, and accumulating the results of parallel processing with the results of multiplying L vectors (matrix elements) by one vector element in the next cycle.

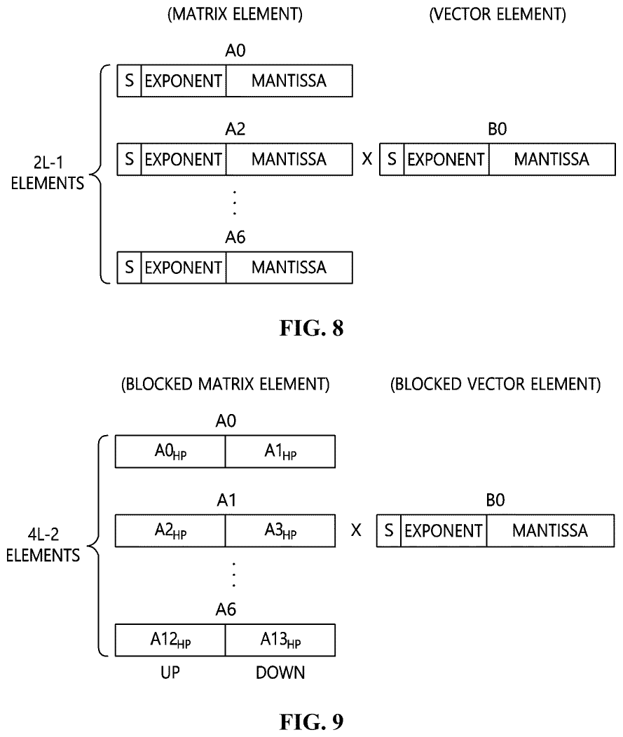

Further, the port-extended matrix-vector multiplication illustrated in FIG. 8 relates to the matrix-vector multiplication operation structure according to the embodiment of the present disclosure illustrated in FIG. 3, and may correspond to a structure for multiplying 2L-1 N-bit vectors (matrix elements) derived from a matrix in each cycle by one N-bit vector element.

Furthermore, the port-flipped half-precision matrix-vector multiplication illustrated in FIG. 9 is an extension of the port-extended technique illustrated in FIG. 8, and relates to the matrix-vector multiplication operation structure according to the embodiment of the present disclosure illustrated in FIGS. 4 and 5. Referring to FIG. 9, this structure may correspond to a structure for multiplying 4L-2 N/2-bit vectors (blocked matrix elements) derived from a matrix in each cycle through 2L-1 vector ports by one N-bit vector element. In this case, multi-data in which two pieces of N/2-bit data are combined with each other may be allocated to each of the 2L-1 vector ports, and an N/2-bit data type forming the multi-data may include various low-precision data formats such as a floating-point format, an integer format, and a blocked floating-point format.

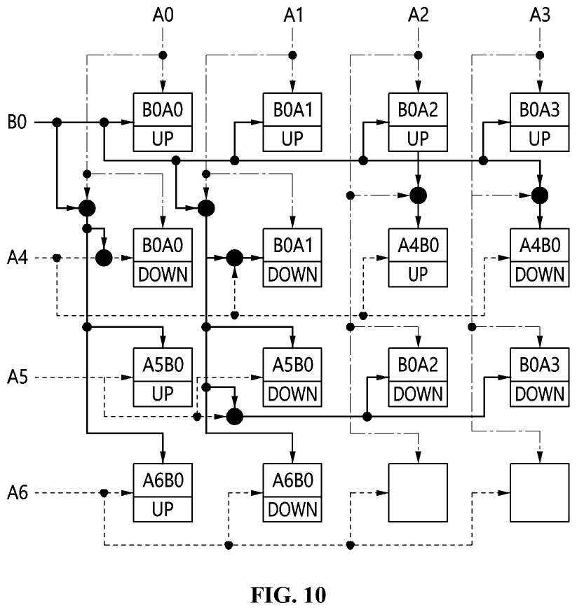

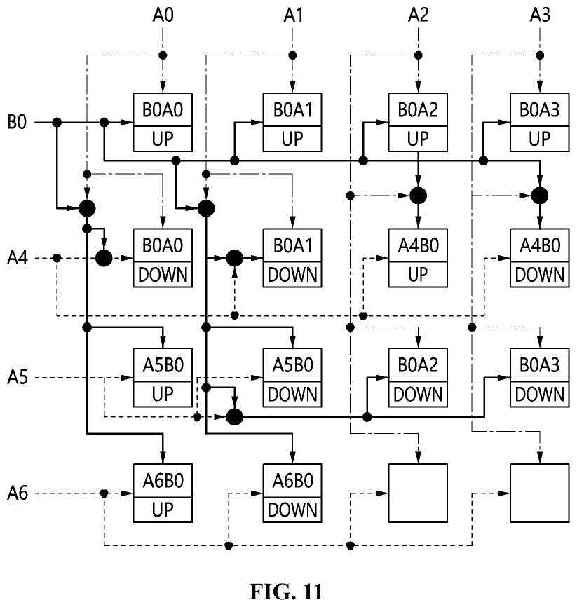

In this case, according to the present disclosure, because an element port to which a vector element is input may be located at any of interfaces corresponding to each row or column, the element port may be changed to and operated in the structure illustrated in FIG. 10 when the element port located in a column in FIG. 3 is moved to a row. In the same manner, the structure illustrated in FIG. 4 may be changed to and operated in the structure illustrated in FIG. 11.

In this case, multi-data may be generated by performing type conversion in which the data type of half-precision data or data having a size smaller than that of the half-precision data is taken into consideration.

For example, type conversion may be performed in consideration of the data type of half-precision data having a 16-bit size or FP8 data having an 8-bit size smaller than that of the half-precision data.

Here, when the data type of the half-precision data is an exponent-bias floating-point data type, the range of a result value may be corrected by subtracting a preset exponent bias from the result value of the matrix-vector multiplication operation.

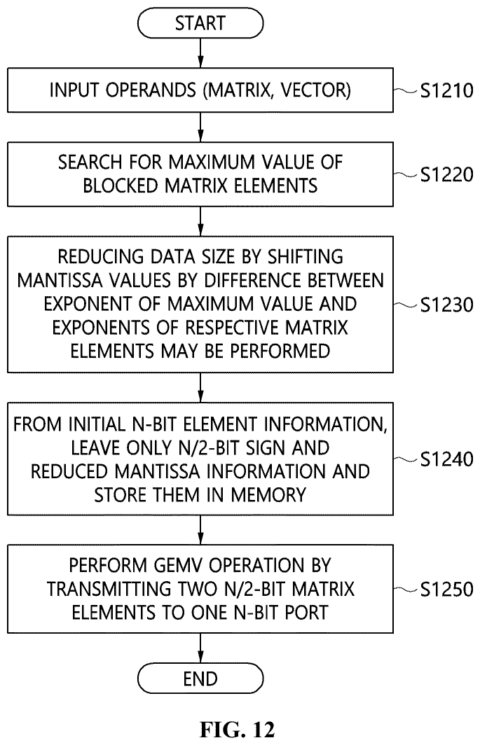

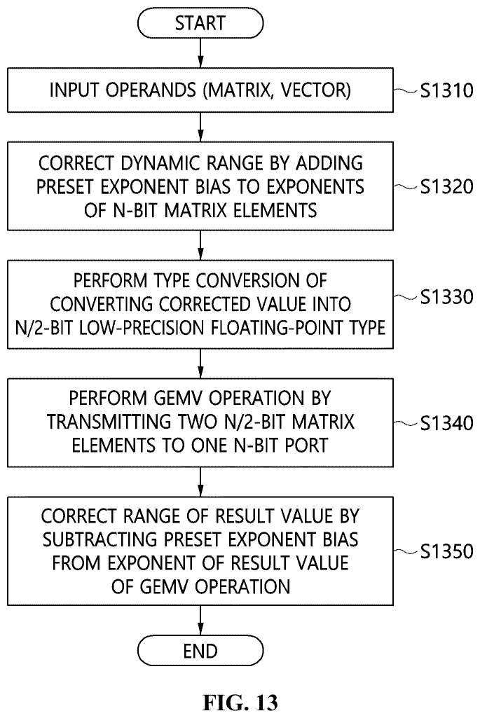

Hereinafter, processing procedures performed in the case where half-precision data is used in a block floating-point format (data type) and in the case where the half-precision data is used in an exponent-bias floating-point format will be described in detail with reference to FIGS. 12 and 13.

First, referring to FIG. 12 in which a block floating-point format is used, when a matrix and a vector, which are operands, are input at step S1210, a maximum value among 4L-2 vectors (N-bit matrix elements) derived from the matrix may be searched for at step S1220.

Thereafter, type conversion of reducing a data size by shifting the mantissa values of vectors of the matrix (N-bit matrix elements) to the right by the difference between the exponent of the found maximum value and the exponents of respective vectors of the matrix (N-bit matrix elements) may be performed at step S1230.

Here, step S1230 may correspond to a detailed process of converting the vectors of the matrix (N-bit matrix elements) into a block floating-point format, and this process may be represented by the following Equation (1):

$${S}_{i} = sign of {A}_{i} \\ {E}_{i} = exponent of {A}_{i} \\ {M}_{i} = mantissa of {A}_{i} \\ {E}_{max} = max ( \{ {E}_{0} , {E}_{1} , … , {E}_{13} \} ) \\ {M}_{BFP , i} = {M}_{i} >> ( {E}_{max} - {E}_{i} ) \\ {A}_{HP , i} = {S}_{i} * {M}_{BFP , i} \\ {B}_{BDP , 0} = {B}_{0} * {E}_{max} \qquad ( 1 )$$

In this case, by means of Equation (1), the vectors of the matrix (N-bit matrix elements) may be represented by a common maximum exponent value. Therefore, the common exponent information may be removed from the vectors of the matrix (N-bit matrix elements), and N/2-bit matrix elements in which only a sign and mantissa information are left may be stored in memory at step S1240.

Here, the maximum exponent value may be represented to be added to the exponent of the element of the vector that is the operand input at step S1210.

Thereafter, the outer product-based matrix-vector multiplication operation apparatus according to the present disclosure may perform a matrix-vector multiplication (i.e., General Matrix Vector Multiplication; GEMV) operation by transmitting two N/2-bit matrix elements to a data input port (N-bit port) of an array composed of internal calculators at step S1250.

Meanwhile, referring to FIG. 13 in which an exponent-bias floating-point format is used, when a matrix and a vector, which are operands, are input at step S1310, the range of values (dynamic range) may be corrected by adding a preset exponent bias to the exponents of 4L-2 vectors (N-bit matrix elements) derived from the matrix at step S1320.

Thereafter, type conversion of converting the corrected vectors (N-bit matrix elements) into an N/2-bit low-precision floating-point type may be performed at step S1330.

Here, a process ranging from step S1320 to step S1330 may be represented by the following Equation (2):

$${A}_{Biased , i} = {A}_{i} * {E}_{Bias} \\ {A}_{LP , i} = ( \frac{N}{2} ) bit Low Precision FP of {A}_{Biased , i} \\ {Y}_{Biased , i} = {\sum }_{n = 0}^{K} ( {A}_{LP , in} * {B}_{n} ) \\ {Y}_{i} = {Y}_{Biased , i} / {E}_{Bias} \qquad ( 2 )$$

Thereafter, the outer product-based matrix-vector multiplication operation apparatus according to the present disclosure may perform a matrix-vector multiplication (i.e., General Matrix Vector Multiplication; GEMV) operation by transmitting two N/2-bit matrix elements to a data input port (N-bit port) of an array composed of internal calculators at step S1340.

Thereafter, the range of the final result value of the GEMV operation may be corrected by subtracting the preset exponent bias, used at step S1320, from the exponent of the result value of the GEMV operation at step S1350.

In this case, the N/2-bit low-precision floating-point type according to an embodiment of the present disclosure may include all cases that may occur at the bitwidth of an exponent and a mantissa within an N/2-bit range.

As described above, in order to utilize an extended input structure according to the present disclosure for the conventional calculator structure illustrated in FIG. 2 without change, various operating conditions need to be satisfied and such operating conditions are summarized as follows.

1. For each internal calculator, only two pieces of input data corresponding to the vector of a matrix and a vector element are permitted.

2. In the case of the structure illustrated in FIG. 3, the vector of a matrix that is input in accordance with each of row operands A3 to A6 and column operands A0 to A2 may be allocated to and processed in one internal calculator. In an example, in FIG. 3, a vector port corresponding to A3 may be allocated only to one internal calculator A3B0 among four internal calculators disposed in a horizontal direction, and input to the remaining three internal calculators B0A0, B0A1, and B0A2 may be bypassed. In another example, in FIG. 3, a vector port corresponding to A0 may be allocated only to one internal calculator B0A0 among four internal calculators disposed in a vertical direction, and input to the remaining three internal calculators may be bypassed.

3. In the case of the structure illustrated in FIGS. 4 and 5, the vector of a matrix that is input in accordance with each of row operands A3 to A6 and column operands A0 to A2 may be allocated to and processed in two internal calculators. In an example, in FIG. 4, a vector port corresponding to A3 may be allocated to two internal calculators A3B0-UP and A3B0-DOWN among four internal calculators disposed in a horizontal direction, and input to the remaining two internal calculators B0A1-UP and B0A2-UP may be bypassed. In another example, in FIG. 4, a vector port corresponding to A0 may be allocated to two internal calculators B0A0-UP and B0A0-DOWN among four internal calculators disposed in a vertical direction, and input to the remaining two internal calculators A3B0-DOWN and A4B0-DOWN may be bypassed. In this case, one N-bit input port for transmitting the vector of the matrix includes two pieces of N/2-bit vector data (multi-data), and each of the internal calculators may utilize the remaining unmasked portion for the operation by masking upper N/2-bit data or lower N/2-bit data of the multi-data.

By means of the outer product-based matrix-vector multiplication operation apparatus, the structure of a matrix-matrix multiplication operation apparatus of AI semiconductor may be reused without change while a matrix-vector multiplication operation may be accelerated.

Further, the present disclosure may maximize a memory interface utilization rate and improve the utilization of calculators by transmitting a larger number of operands at the same memory bandwidth in combination with a data lightweighting technique.

Furthermore, the present disclosure may expand the utilization range of AI semiconductor and improve learning ability by enhancing the speed of the primary operation (i.e., matrix-vector multiplication) of the next-generation neural network architecture.

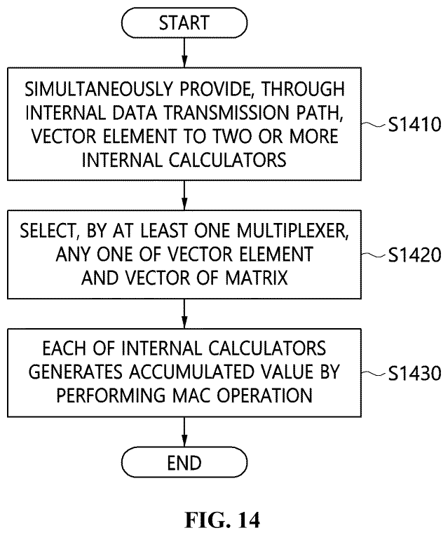

FIG. 14 is an operation flowchart illustrating an outer product-based matrix-vector multiplication operation method according to an embodiment of the present disclosure.

Referring to FIG. 14, the outer product-based matrix-vector multiplication operation method according to the embodiment of the present disclosure simultaneously provides a vector element to two or more internal calculators through an internal data transmission path at step S1410.

Further, in the outer product-based matrix-vector multiplication operation method according to the embodiment of the present disclosure, at least one multiplexer selects any one of the vector element and the vector of a matrix at step S1420.

Furthermore, in the outer product-based matrix-vector multiplication operation method according to the embodiment of the present disclosure, each of the internal calculators generates an accumulated value by performing a Multiply-Accumulation (MAC) operation at step S1430.

In this case, a first input port of each of the internal calculators may be connected to one of vectors of the matrix and a second input port of each of the internal calculators may be connected to the vector element.

In this case, one element port, among data input ports of an array composed of the internal calculators, may be allocated to the vector element, and vector ports of the data input ports, other than the one element port, may be allocated to the vectors of the matrix.

In this case, at least one multiplexer may be provided such that the vector element can be provided to all internal calculators to which the vectors of the matrix are allocated in consideration of the location of the element port.

In this case, when each of the vectors of the matrix is multi-data into which two pieces of half-precision data, having decreased precision by reducing the number of bits in the mantissa and the exponent in a floating-point data type, are combined with each other, the multi-data may be simultaneously input to two internal calculators.

In this case, one of the two internal calculators may perform an operation based on an upper bit by masking a lower bit in the multi-data, and the other of the two internal calculators may perform an operation based on a lower bit by masking an upper bit in the multi-data.

In this case, the two internal calculators are located in the same row or the same column in the array, but they may be arranged in the order of a first internal calculator which performs an operation based on the upper bit, and a second internal calculator which performs an operation based on the lower bit.

In this case, multi-data may be generated by performing type conversion in which the data type of half-precision data or data having a size smaller than that of the half-precision data is taken into consideration.

Here, when the data type of the half-precision data is an exponent-bias floating-point type, the range of a result value may be corrected by subtracting a preset exponent bias from the result value of the matrix-vector multiplication operation.

By means of the outer product-based matrix-vector multiplication operation method, the structure of a matrix-matrix multiplication operation apparatus of AI semiconductor may be reused without change while a matrix-vector multiplication operation may be accelerated.

Further, the present disclosure may maximize a memory interface utilization rate and improve the utilization of calculators by transmitting a larger number of operands at the same memory bandwidth in combination with a data lightweighting technique.

Furthermore, the present disclosure may expand the utilization range of AI semiconductor and improve learning ability by enhancing the speed of the primary operation (i.e., matrix-vector multiplication) of the next-generation neural network architecture.

According to the present disclosure, there can be provided a hardware architecture, which can accelerate matrix-vector multiplication operations while reusing the matrix-matrix multiplication operation apparatus structure of Artificial Intelligence (AI) semiconductor.

Further, the present disclosure may maximize a memory interface utilization rate and improve the utilization of calculators by transmitting a larger number of operands at the same memory bandwidth in combination with a data lightweighting technique.

Furthermore, the present disclosure may expand the utilization range of AI semiconductor and improve learning ability by enhancing the speed of the primary operation (i.e., matrix-vector multiplication) of the next-generation neural network architecture.

As described above, in the outer product-based matrix-vector multiplication operation apparatus and the method using the apparatus according to the present disclosure, the configurations and schemes in the above-described embodiments are not limitedly applied, and some or all of the above embodiments can be selectively combined and configured such that various modifications are possible.

What is claimed is:

1. An outer product-based matrix-vector multiplication operation apparatus, comprising:
internal calculators, each configured to generate an accumulated value by performing a Multiply-Accumulation (MAC) operation;
an internal data transmission path configured to simultaneously provide a vector element to two or more internal calculators; and
at least one multiplexer configured to select any one of the vector element and a vector of a matrix,
wherein a first input port of each of the internal calculators is connected to one of vectors of the matrix and a second input port of each of the internal calculators is connected to the vector element.

2. The outer product-based matrix-vector multiplication operation apparatus of claim 1, wherein one element port, among data input ports of an array composed of the internal calculators, is allocated to the vector element, and vector ports, other than the one element port, among the data input ports, are allocated to the vectors of the matrix.

3. The outer product-based matrix-vector multiplication operation apparatus of claim 2, wherein, when each of the vectors of the matrix is multi-data into which two pieces of half-precision data, having decreased precision by reducing a number of bits in a mantissa and an exponent in a floating-point data type, are combined with each other, the multi-data is simultaneously input to two internal calculators.

4. The outer product-based matrix-vector multiplication operation apparatus of claim 3, wherein one of the two internal calculators performs an operation based on an upper bit by masking a lower bit in the multi-data, and a remaining one of the two internal calculators performs an operation based on a lower bit by masking an upper bit in the multi-data.

5. The outer product-based matrix-vector multiplication operation apparatus of claim 4, wherein the two internal calculators are located in an identical row or an identical column in the array, and are arranged in an order of a first internal calculator which performs an operation based on the upper bit and a second internal calculator which performs an operation based on the lower bit.

6. The outer product-based matrix-vector multiplication operation apparatus of claim 2, wherein the at least one multiplexer is provided such that the vector element is capable of being provided to all internal calculators to which the vector of the matrix is allocated in consideration of a location of the element port.

7. The outer product-based matrix-vector multiplication operation apparatus of claim 3, wherein the multi-data is generated by performing type conversion in which a data type of half-precision data or data having a size smaller than that of the half-precision data is taken into consideration.

8. The outer product-based matrix-vector multiplication operation apparatus of claim 7, wherein, when the data type of the half-precision data is an exponent-bias floating-point data type, a range of a result value of a matrix-vector multiplication operation is corrected by subtracting a preset exponent bias from the result value.

9. An outer product-based matrix-vector multiplication operation method, comprising:
simultaneously providing, through an internal data transmission path, a vector element to two or more internal calculators;
selecting, by at least one multiplexer, any one of a vector element and a vector of a matrix; and
generating, by each of internal calculators, an accumulated value by performing a Multiply-Accumulation (MAC) operation,
wherein a first input port of each of the internal calculators is connected to one of vectors of the matrix and a second input port of each of the internal calculators is connected to the vector element.

10. The outer product-based matrix-vector multiplication operation method of claim 9, wherein one element port, among data input ports of an array composed of the internal calculators, is allocated to the vector element, and vector ports, other than the one element port, among the data input ports, are allocated to the vectors of the matrix.

11. The outer product-based matrix-vector multiplication operation method of claim 10, wherein, when each of the vectors of the matrix is multi-data into which two pieces of half-precision data, having decreased precision by reducing a number of bits in a mantissa and an exponent in a floating-point data type, are combined with each other, the multi-data is simultaneously input to two internal calculators.

12. The outer product-based matrix-vector multiplication operation method of claim 11, wherein one of the two internal calculators performs an operation based on an upper bit by masking a lower bit in the multi-data, and a remaining one of the two internal calculators performs an operation based on a lower bit by masking an upper bit in the multi-data.

13. The outer product-based matrix-vector multiplication operation method of claim 12, wherein the two internal calculators are located in an identical row or an identical column in the array, and are arranged in an order of a first internal calculator which performs an operation based on the upper bit and a second internal calculator which performs an operation based on the lower bit.

14. The outer product-based matrix-vector multiplication operation method of claim 10, wherein the at least one multiplexer is provided such that the vector element is capable of being provided to all internal calculators to which the vector of the matrix is allocated in consideration of a location of the element port.

15. The outer product-based matrix-vector multiplication operation method of claim 11, wherein the multi-data is generated by performing type conversion in which a data type of half-precision data or data having a size smaller than that of the half-precision data is taken into consideration.

16. The outer product-based matrix-vector multiplication operation method of claim 15, wherein, when the data type of the half-precision data is an exponent-bias floating-point data type, a range of a result value of a matrix-vector multiplication operation is corrected by subtracting a preset exponent bias from the result value.
